(19) United States
(12) Patent Application Publication
(10) Pub. No.: US 2008/0043294 A1
(43) Pub. Date: Feb. 21, 2008

(54) Double-side scanning mechanism

(76) Inventors: Yu-Jen Su, Taipei (TW); Hsun-Hao Chan, Sinpu Township (TW); Shu-Ya Chiang, Taichung (TW); Liang-Qing Su, Renwu Township (TW); Chung-Yi Cheng, Taichung (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/889,869

(22) Filed: Aug. 17, 2007

(30) Foreign Application Priority Data
Aug. 18, 2006 (TW) 095130493

(51) Int. Cl. H04N 1/04

(52) U.S. Cl. 358/474

(57) ABSTRACT

A double-side scanning mechanism for capturing images of a paper having two pages includes a second transparent element disposed corresponding to an outer side of a first transparent element and parallel to the first transparent element. A paper conveying device conveys a paper to pass between the first and the second transparent elements with a first page facing the first transparent element. The paper is flipped and passes over the outer side of the second transparent element with a second page facing the second transparent element. An image scanning module is disposed corresponding to an inner side of the first transparent element, for capturing the image of the first page when the paper passes between the first and the second transparent elements, and capturing the image of the second page when the paper passes over an outer side of the second transparent element.

### CROSS-REFERENCE TO RELATED APPLICATIONS

This non-provisional application claims priority under 35 U.S.C. §119(a) on Patent Application No(s). 095130493 filed in Taiwan, R.O.C. on Aug. 18, 2006, the entire contents of which are hereby incorporated by reference.

### BACKGROUND OF THE INVENTION

1. Field of Invention

The present invention relates to a double-side scanning mechanism, and more particularly, to a double-side scanning mechanism capable of improving both the one-side and double-side scanning speeds.

2. Related Art

A scanning method using a one-side scanning mechanism to scan both pages of a paper requires the paper to be flipped manually by a user after one page is scanned to proceed the scanning of the other page, which has a low speed and results in the problem of inconsistent paper conveying direction. A double-side scanning mechanism is capable of scanning two pages of the paper automatically. Thus, the user can finish the scanning of two pages of one paper rapidly, and the problem of inconsistent paper conveying direction can be avoided.

Among the double-side scanning mechanisms, a part of the designs uses two scanning modules to scan two pages of a paper respectively, such as U.S. Patent Publications No. U.S. Pat. No. 4,536,077 and U.S. Pat. No. 5,680,204, or the early publication of U.S. Patent Application No. 2005/0213168. However, this type of designs leads to a large volume of the scanning apparatus and the high cost of the two scanning modules. Therefore, the design to flip a paper to achieve the double-side scanning is proposed. For example, in U.S. patent publication No. U.S. 5,430,536, an intersected path is connected between an entrance section and an exit section of a paper conveying path. When the printing or scanning of the first page of the paper is complete, the paper conveying mechanism drives the paper back to the intersected path, such that the paper returns to the paper conveying path through the intersected path to perform the printing or scanning of the second page. In this method, the paper must repeat traveling in the entire paper conveying path, thus prolonging the traveling path and consuming more time. In addition, the order of the paper sheets in the paper cassette is reversed, causing the trouble of rearranging the order of the paper to the user.

FIGS. 1 and 2 show another double-side scanning module disclosed in U.S. Patent Publication No. U.S. 6,563,611. In U.S. Pat. No. 6,563,611, a paper P is conveyed to a scanning area 510 by paper pickup rollers 410, with the first page facing a transparent window 511, such that an image capturing device 420 captures the image of the first page of the paper P. Then, a direction control roller 430 conveys the paper P to a flipping path 520, and conveying rollers 440 continue to convey the paper P to move in the flipping path 520. After the paper P is flipped, it returns to the scanning area 510. The direction control roller 430 rotates in an opposite direction to drive the paper P to pass through the scanning area 510. At this time, the paper P faces the image capturing device 420 with the second page, such that the image capturing device 420 captures the image of the second page of the paper P as the image capturing device 420 is in the transparent window 511. Then the paper P is then conveyed to a paper exit 530.

In U.S. Pat. No. 6,563,611, in order to flip the paper to make the first page and the second page facing the transparent window 511 respectively, a single sheet of paper must pass through the scanning area 510 twice, and the conveying paths are the same one. Therefore, the paper conveying track is capable of accommodating a single sheet of paper at one time. If being applied in one-side scanning, the paper is still flipped and passes through the scanning area 510 twice. Thus, when multiple sheet of paper requires one side to be scanned, the second sheet of paper P must wait until the rear end of the first paper sheet P reaches the paper exit 530 before being taken into the scanning area 510 by the paper pickup rollers 410. As such, the time for waiting causes a great interval between two sheets of paper P, which not only reduces the number of paper sheets P passing through in a unit of time and increases the operation time of the image capturing device 420, but also increases the waiting time of the user and lowers the image processing efficiency. Therefore, this design is not economical for users who want to scan only one side of paper.

### SUMMARY OF THE INVENTION

According to the prior art disclosed above, the design of the double-side scanning mechanism is too complicated, thus resulting in a low speed of conveying the paper in the paper conveying path. In view of the above, the object of the present invention is to provide a double-side scanning mechanism to simplify the design and improve the paper conveying speed, thereby improving the processing efficiency of the scanning.

In order to achieve the aforementioned object, the double-side scanning mechanism disclosed in the present invention is used to convey a paper and capture images of the paper. The paper has a first page and a second page. The double-side scanning mechanism includes a first transparent element, a second transparent element, a paper conveying device, and an image scanning module. The second transparent element is disposed corresponding to an outer side of the first transparent element and parallel to transparent element. The paper conveying device is used to convey the paper to pass between the first transparent element and the second transparent element with the first page facing the first transparent element. Then, the paper passes over the outer side of the second transparent element with the second page facing the transparent element. The image scanning module is disposed corresponding to an inner side of the first transparent element, for capturing the image of the first page when the paper passes between the first transparent element and the second transparent element, and capturing the image of the second page when the paper passes over the outer side of the second transparent element. Thus, when being conveyed and scanned, the paper moves in only one direction and does not pass over a same path again, which cause a significant increase of the paper conveying speed.

The efficacy of the present invention is that the paper conveying path of the double-side scanning mechanism disclosed in the present invention is not repeated. Therefore, the moving direction of the paper when being conveyed and scanned will not change, and the paper conveying device operates continuously without stop. As the paper conveying path is not repeated, multiple sheets of paper can be accommodated in the double-side scanning mechanism to be conveyed and scanned at the same time when the one-side scanning is performed. When the double-side scanning is performed, the paper is conveyed continuously without the necessity to stop and move backward. Therefore, the paper conveying speed of the present invention is higher than that of the double-side scanning mechanism utilizing paths to flip the paper in the conventional art, thereby significantly improving the processing efficiency of the scanning.

The features and advantages of the present invention are described in detail in the following embodiments, and the technical content of the present invention is apparent to those skilled in the art and can be implemented by those skilled in the art with reference to the description. The objectives and advantages of the invention will become apparent to those skilled in the art from this detailed description of the embodiments, the claims, and the drawings.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, and thus are not limitative of the present invention, and wherein:

FIG. 1 is a schematic structural view of a conventional double-side scanning mechanism;

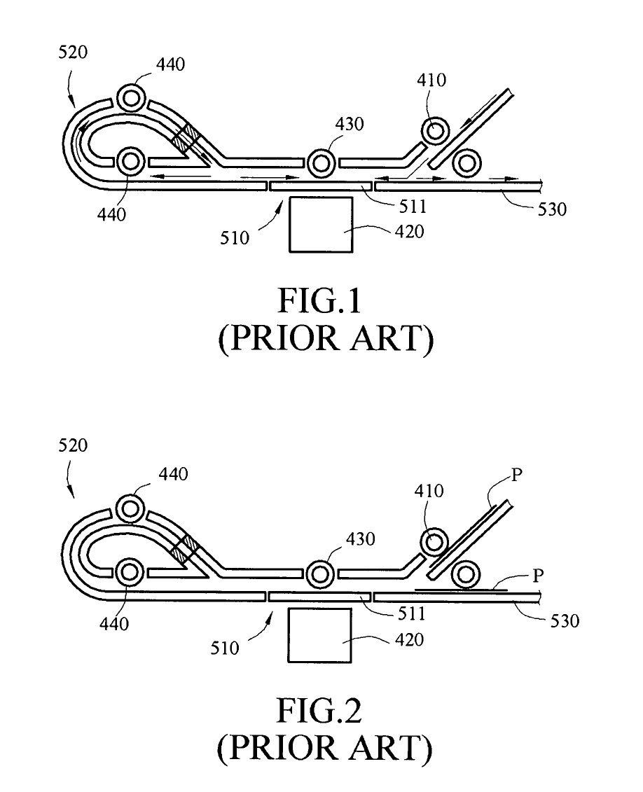

FIG. 2 shows the operation state of the conventional double-side scanning mechanism;

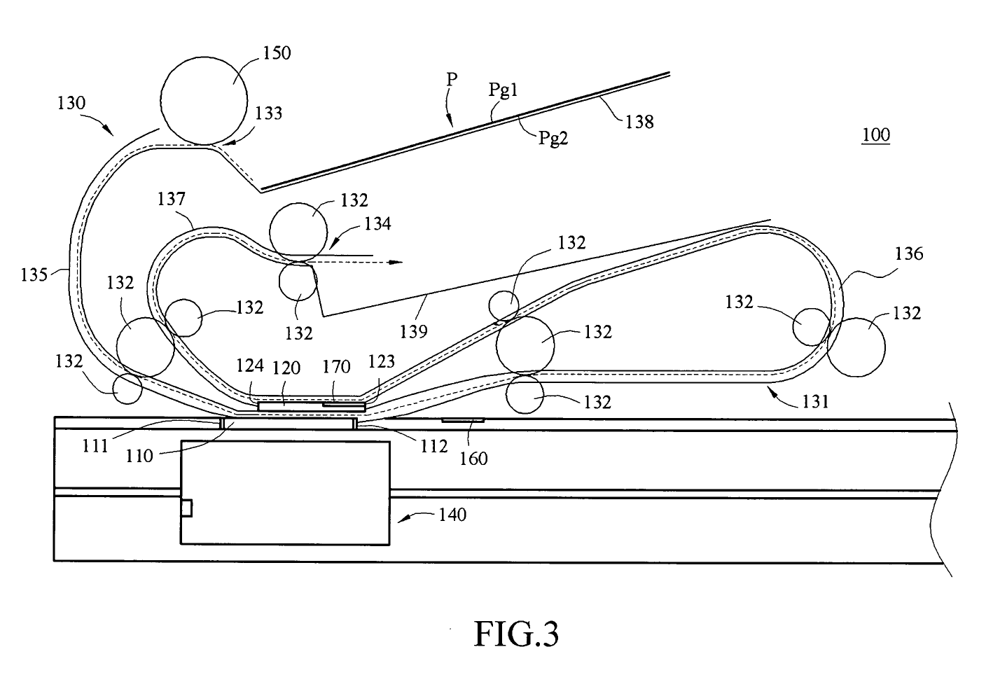

FIG. 3 is a schematic structural view of an embodiment of the present invention;

FIG. 4 shows the operation state of an embodiment of the present invention; and

FIGS. 5A and 5B are schematic structural views of image capturing in the present invention.

### DETAILED DESCRIPTION OF THE INVENTION

The double-side scanning mechanism disclosed in the present invention is applicable to, but is not limited to, multi function peripherals (MFPs), scanners, and printers, etc. However, the present invention is not limited to be applied in the aforementioned devices, and can also be applied in various electronic devices having the function of capturing images of paper.

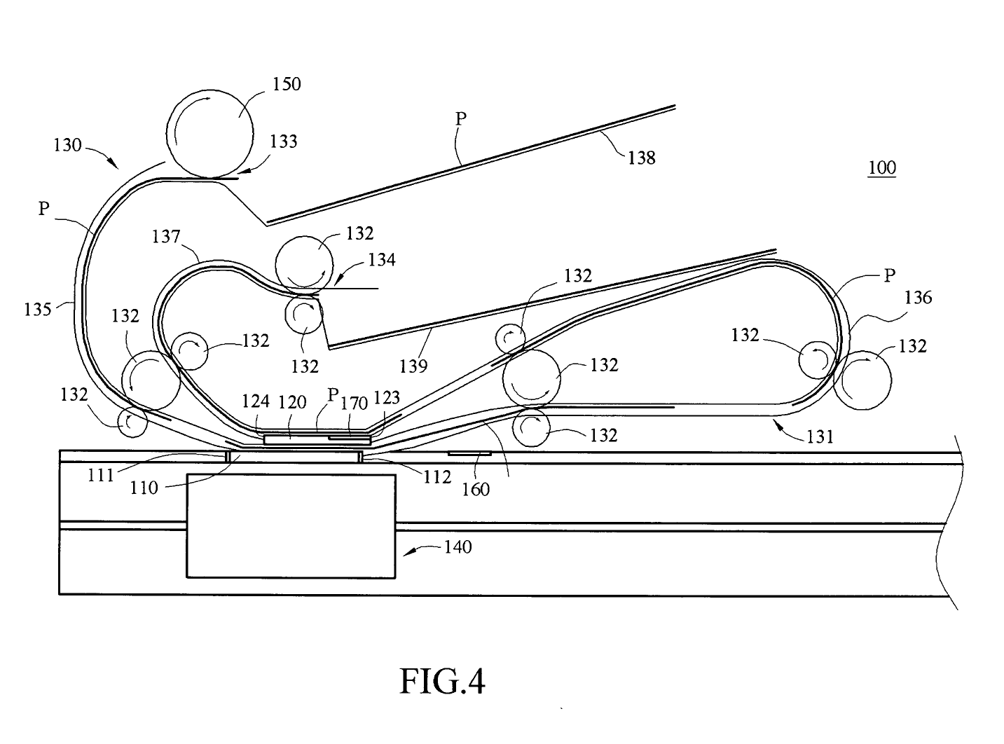

Please refer to FIG. 3 of a schematic sectional view of a double-side scanning mechanism 100 according to an embodiment of the present invention. The double-side scanning device 100 is used to capture images of a first page Pg1 and a second page Pg2 of a paper P, and then convey the paper P out of the double-side scanning mechanism 100.

The double-side scanning mechanism 100 includes a first transparent element 110, a second transparent element 120, a paper conveying device 130, and an image scanning module 140.

The first transparent element 110 and the second transparent element 120 are arranged in parallel, wherein the second transparent element 120 is disposed corresponding to an outer side of the first transparent element 110 and parallel to the first transparent element 110. The transparent element 110 includes a first end 111 and a second end 112, and the second transparent 120 includes a third end 123 corresponding to the second end 112 and a fourth end 124 corresponding to the first end 111.

The paper conveying device 130 includes a paper conveying track 131 and a plurality of conveying rollers 132 arranged along the paper conveying track 131. The conveying rollers 132 are controlled by the power source to rotate in a predetermined forward direction to convey the paper P moving in the paper conveying track 131.

The paper conveying track 131 has an entrance end 133 and an exit 134 for the paper P to enter and leave the paper conveying track 131 respectively. A paper pickup device, for example, a paper pickup roller 150, is disposed at the entrance end 133 to pick up the paper P into the paper conveying track 131 via the entrance end 133.

The paper conveying track 131 passes between the first transparent element 110 and the second transparent element 120, and passes over the outer side of the second transparent element 120. The paper conveying track 131 is divided into three sections, namely, an entrance section 135, a flipping section 136, and an exit section 137. Two ends of the entrance section 135 are connected to the entrance end 133 and the first end 111 of the first transparent element 110 respectively, and two ends of the flipping section 136 are connected to the second end 112 of the transparent element 110 and the third end 123 of the second transparent element 120 respectively to form a return path, such that the paper P can be flipped when passing through the flipping section 136. Two ends of the exit section 137 are connected to the fourth end 124 of the second transparent element 120 and the exit end 134 respectively. A paper tray 138 is further disposed at the entrance end 133 for accommodating a plurality of paper sheets P to be scanned, such that the paper pickup roller 150 can pick up the paper P into the paper conveying track 131 sequentially. A paper exit 139 is disposed at the exit end 134 for carrying the paper P leaving the paper conveying track 131. The plurality of paper sheets P is placed on the paper tray 138 in order in advance, with the second pages Pg2 facing the paper tray 138 (i.e., the first pages Pg1 facing upward), and the first paper sheet P is placed on the top with the first page Pg1 facing upward. Thus, the plurality of paper sheets P can keep the original order, and does not need to be rearranged for scanning.

The image scanning module 140 is disposed corresponding to the inner side of the first transparent element 110, such that the image scanning module 140 captures the images of the paper P through the first transparent element 110 and the second transparent element 120. The image scanning module 140 is, but not limited to, a charge coupled device (CCD) or a contact image sensor (CIS). Moreover, in order to provide the color calibration reference for the calibration of the image scanning results to the image scanning module 140 to calibrate image the scanning results, the double-side scanning mechanism 100 further includes a first calibration sheet 160 and a second calibration sheet 170. The first calibration sheet 160 is placed on the same horizontal plane with the outer side surface of the first transparent 110. That is, when the paper P passes over the outer side surface of the first transparent element 110, the first calibration sheet 160 is placed on the same horizontal plane with the paper P, so as to provide the color calibration reference to the image scanning module 140 to scan the paper P. The second calibration sheet 170 is arranged on the outer side surface of the second transparent element 120. When the paper P passes over the outer side surface of the second transparent element 120, the second calibration sheet 170 is placed on the same horizontal plane with the paper P, so as to provide the color calibration reference to the image scanning module 140 to scan the paper P. The image scanning module 140 must use the first transparent element 110 and the second transparent element 120 to read the image data of the paper P, while the focal plane of the image scanning module 140 is limited. The depth of field cannot be too great, otherwise the scanning effect is not satisfying. Therefore, the interval between the first transparent element 110 and the second transparent element 120 must be controlled within 2 mm to provide the optimal effect.

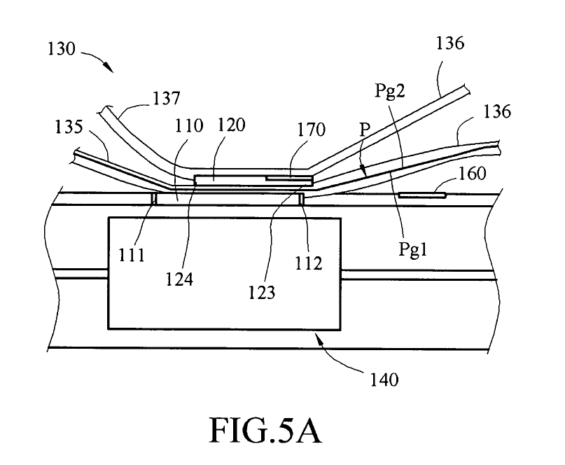

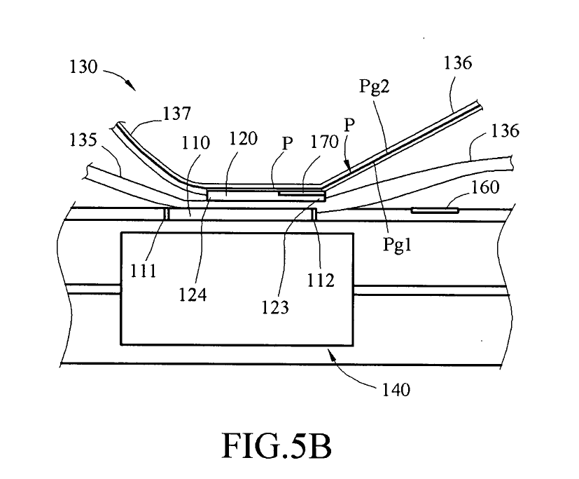

Referring to FIGS. 4 and 5A, when the paper P is picked up from the paper tray 138 by the paper pickup roller 150 and enters the paper conveying device 130, the paper P is driven by the conveying rollers 132 rotating forward, and moves along the paper conveying track 131, and then arrives at the first end 111 of the first transparent element 110 via the entrance section 135. Here, the paper P faces the first transparent element 110 with the first page Pg1, and passes between the first transparent element 110 and the second transparent element 120 from the outer side surface of the first transparent element 110. At this time, the image scanning module 140 reads the image of the first calibration sheet 160 as the color calibration reference, and then captures the image of the first page Pg1.

Referring to FIGS. 4 and 5B, the paper P then leaves the passage between the first transparent element 110 and the second transparent element 120 via the second end 112, and enters the flipping section 136. At this time, the conveying rollers 132 still rotate forward, and do not need to rotate backward. The paper P in the flipping section 136 is flipped. Then, the paper P reaches the outer side surface of the second transparent element 120 through the third end 123. At this time, the paper P faces the second transparent element 120 with the second page Pg2. The image scanning module 140 can capture the images of the second calibration sheet 170 disposed at the outer side surface of the second transparent element 120 and of the second page Pg2 of the paper P at one time through the first transparent element 110 and the second transparent element 120. The image of the second calibration sheet 170 is taken as the color calibration reference to calibrate the capture result of the second page Pg2. Thus, the image capturing process of the double-side scanning operation of the paper P is complete.

As shown in FIG. 4, the paper P leaves second transparent element 120 from the fourth end 124, and enters the exit section 137. At this time, the conveying rollers 132 still rotate forward so as to guide the paper P to the exit end 134 and to enter the paper exit 139 with the first page Pg1 facing the paper exit 139. Thus, the plurality of scanned paper sheets P can be sequentially arranged on the paper exit 139 with the first page Pg1 facing downward, and the order of the paper sheets P is kept.

In the double-side scanning mechanism 100 disclosed in the embodiment of the present invention, no matter whether the one-side or double-side scanning is performed, the paper P moves in a single path formed by the paper conveying track 131 continuously, and does not repeat the intersected path or move in the same section to and fro. Therefore, the conveying rollers 132 only need to rotate forward continuously to convey the paper P and reverse the first page Pg1 and the second page Pg2. In the double-side scanning mechanism of the conventional art, the paper must pass through the track in the image scanning area twice even if the only one side is required to be scanned. Therefore, in each scan, no matter one-side or double-side scanning, the paper conveying mechanism only allows conveying one sheet of paper, and the paper conveying mechanism must stop and rotate backward, thus limiting and significantly lowering the speed of conveying paper. However, in the present invention, the paper P continuously moves in the paper conveying track 131 no matter whether one-side scanning or double-side scanning is performed, and does not repeat the intersected path. Especially when the one-side scanning is performed, a plurality of paper sheets P can be conveyed in the paper conveying track 131 as long as the interval between the paper sheets P is controlled properly. Thus, the efficiency of the one-side scanning is improved significantly. Even is the double-side scanning is performed, as the conveying rollers 132 only need to rotate forward continuously to reverse the first page Pg1 and the second page Pg2 of the paper P without the necessity to stop or rotate backward, the conveying speed is still higher than that of the conventional double-side scanning mechanisms.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A double-side scanning mechanism for conveying a paper having a first page and a second page, and capturing images of the paper, comprising:
a first transparent element;
a second transparent element disposed corresponding to an outer side of the first transparent element and parallel to the first transparent element;
a paper conveying device for conveying the paper to pass between the first transparent element and the second transparent element with the first page facing the first transparent element, and to pass over the second transparent element with the second page facing the second transparent element; and
an image scanning module disposed corresponding to an inner side of the first transparent element, for capturing images of the first page and the second page.

2. The double-side scanning mechanism as claimed in claim 1, wherein a distance between the first transparent element and the second transparent element is no greater than 2 mm.

3. The double-side scanning mechanism as claimed in claim 1, wherein the first transparent element has a first end and a second end and the second transparent element has a third end and a fourth end; the third end corresponds to the second end, and the fourth end corresponds to the first end; the paper passes between the first transparent element and the second transparent element via the first end, and leaves the first transparent element via the second end; then the paper passes above the second transparent element via the third end, and leaves the second transparent element via the fourth end.

4. The double-side scanning mechanism as claimed in claim 3, wherein the paper conveying device comprises:
a paper conveying track having an entrance end and an exit end, wherein the paper enters the paper conveying track via the entrance end, and leaves the paper conveying track via the exit end, wherein the paper conveying track passes between the first transparent element and the second transparent element, and passes over the outer side of the second transparent element; and
a plurality of conveying rollers for conveying the paper to move in the paper conveying track.

5. The double-side scanning mechanism as claimed in claim 4, wherein the paper conveying track comprises:
an entrance section connected to the first end;
a flipping section connected to the second end and the third end; and
an exit section connected to the fourth end.

6. The double-side scanning mechanism as claimed in claim 4, further comprising a paper cassette connected to the entrance end for carrying the paper.

7. The double-side scanning mechanism as claimed in claim 4, further comprising a paper pickup device corresponding to the entrance end for picking up the paper into the paper conveying track.

8. The double-side scanning mechanism as claimed in claim 7, wherein the paper pickup device is a paper pickup roller.

9. The double-side scanning mechanism as claimed in claim 1, wherein the image scanning module is a charge coupled device (CCD).

10. The double-side scanning mechanism as claimed in claim 1, wherein the image scanning module is a contact image sensor (CIS).

11. The double-side scanning mechanism as claimed in claim 1, further comprising a first calibration sheet corresponding to the image scanning module, wherein the first calibration sheet is on the same horizontal plane with an outer side surface of the first transparent element.

12. The double-side scanning mechanism as claimed in claim 1, further comprising a second calibration sheet disposed on the outer side of the second transparent element.
